(19) United States
(12) Patent Application Publication
(10) Pub. No.: US 2022/0015347 A1
(43) Pub. Date: Jan. 20, 2022

(54) SOUND WAVE EMISSION SYSTEM AND FISHING BOBBER

(71) Applicants: Futaijing Precision Electronics (Yantai) Co., Ltd., Yantai (CN); FIH (HONG KONG) LIMITED, Kowloon (HK)

(72) Inventor: MENG-HSIEN CHUANG, New Taipei (TW)

(21) Appl. No.: 16/991,324

(22) Filed: Aug. 12, 2020

(30) Foreign Application Priority Data
Jul. 17, 2020 (CN) 202010693871.1

(51) Int. Cl. A01K 93/02; G10K 15/04; G06F 3/16

(52) U.S. Cl. CPC A01K 93/02; G06F 3/165; G10K 15/04

(57) ABSTRACT

A sound wave emission system includes a substrate, a sound wave device, and a power source. The sound wave device is mounted on the substrate and configured to emit sound waves. The power source is mounted on the substrate and electrically coupled to the sound wave device. The volume, rhythm, and duration of the sound waves emitted by the sound wave device are controlled to simulate sounds of different kinds of fish in different situations.

### FIELD

The subject matter herein generally relates to a sound wave emission system and a fishing bobber using the sound wave emission system.

### BACKGROUND

Generally when fishing, different types of fishing tackle are used for catching different types of fish, and fishermen must wait to attract fish. At present, although there are applications that use sound waves to attract fish, their functions are limited, and there are few application scenarios.

### BRIEF DESCRIPTION OF THE DRAWINGS

Implementations of the present disclosure will now be described, by way of embodiments, with reference to the attached figures.

FIG. 1 is an exploded perspective diagram of a sound wave emission system according to an embodiment.

FIG. 2 is an exploded perspective diagram of the sound wave emission system according to another embodiment.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

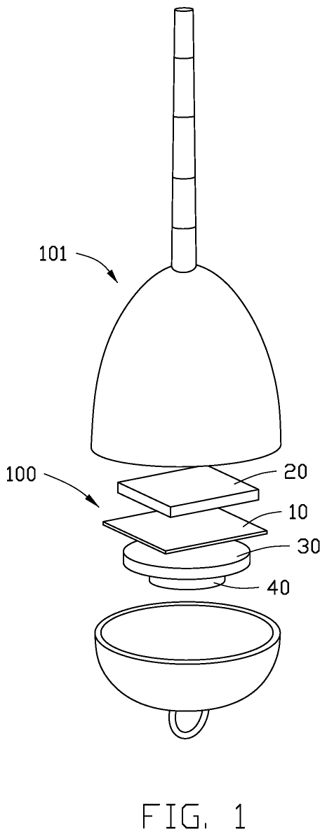

FIG. 1 shows an embodiment of a sound wave emission system 100 for attracting or dispersing fish. The sound wave emission system 100 may be housed in a fishing bobber 101. In one embodiment, the sound wave emission system 100 can be used to emit courtship sounds to attract fish for breeding. The sound wave emission system 100 includes a substrate 10, a power source 20, a sound wave device 30, and a control system (not shown). The power source 20 and the sound wave device 30 are both mounted on the substrate 10. The power source 20 is connected to the sound wave device 30. The control system is electrically connected to the sound wave device 30. In one embodiment, the sound wave emission system 100 is installed inside a fishing bobber 101. In another embodiment, the sound wave emission system 100 is installed on diving equipment such as a life jacket and goggles.

In one embodiment, the substrate 10 includes a substrate body and a mounting portion. The mounting portion is detachably mounted on the substrate body, and the substrate body is used to fix the power supply 20 and the sound wave device 30. The mounting portion is used to fix a main body of the substrate on an object, such as the inside of the fishing bobber 101, a life jacket, goggles, and other diving equipment.

The power source 20 is electrically connected to the sound wave device 30 for powering the sound wave device 30. In one embodiment, the power source 20 is a lithium-ion battery. The power source 20 is detachably disposed on the sound wave device 30 to facilitate charging of the power source 20 for repeated use.

The sound wave device 30 includes a sound wave generator and a control substrate. The sound wave generator is electrically connected to the control substrate. The control substrate is used for controlling the sound wave generator to emit sound waves, and the control substrate includes a wireless module for wirelessly connecting to the control system and wirelessly controlling the operation of the sound wave generator through the control system.

The control system includes a control unit and a communication unit, a setting unit, a storage unit, and a display unit electrically connected to the control unit. In one embodiment, the control system is installed in the housing 102 and used as an independent controller. In another embodiment, the control system can also be installed in a mobile device, such as a mobile phone, a tablet computer, a desktop computer, or the like.

The control unit is electrically connected to the communication unit. The communication unit is wirelessly connected to the wireless module of the control substrate, and a control command of the control unit is sent by the communication unit to the control substrate to control the sound wave generator.

The setting unit is electrically connected to the control unit for setting corresponding sound waves according to different types of fish, and the control unit sends out corresponding control commands to control the sound wave generator to emit corresponding sound waves. In one embodiment, the setting unit may also set the volume of the sound waves to control a sound propagation range of the sound wave generator. Different fish will make a variety of different sounds. The same kind of fish also makes different sounds under different circumstances such as reproduction, feeding, movement, evasion of predators, in groups, or alone. In another embodiment, the setting unit can also set the rhythm of the sound waves and the duration of the sound waves, such as the interval of the sound waves, the length of the sound waves, and the like to simulate the sound frequency corresponding to the fish in various situations and realize multiple functions, such as attracting fish for viewing, fishing, or dispersing fish on the seabed for protection. In one embodiment, by switching the sound frequency of the sound wave generator, multiple different kinds of fish can be attracted in one area.

The storage unit is electrically connected to the display unit. The storage unit stores the sound wave frequencies corresponding to different kinds of fish and the rhythm and duration corresponding to each fish species in different situations, so that the corresponding settings can be set and displayed through the display unit according to different kinds of fish. In one embodiment, the storage unit is further configured to store the times of rising and falling tides in various regions and different kinds of fish that appear along the coast in each season.

The display unit is used to visually display the settings of the setting unit and the storage unit. In one embodiment, the display unit is also used to display weather and temperature conditions in various regions.

In one embodiment, the control system further includes an early warning unit, which is electrically connected to the control unit and the power source 20. When the remaining power of the power source 20 is lower than a set threshold, the early warning unit issues a warning signal, and the control unit receives the warning signal and controls the display unit to display warning information.

In one embodiment, the control system further includes a sensing unit, which is disposed on the substrate 10 and electrically connected to the warning unit for sensing whether there is water leakage when the sound wave emission system 100 is in use. When the liquid is sensed in the sound wave emission system 100, a sensing signal is sent to the early warning unit, the early warning unit issues a warning signal, and the control unit receives the warning signal and controls the display unit to display the warning message. In one embodiment, the sensing unit is a liquid sensor or a liquid level sensor.

The sound wave emission system 100 further includes a waterproof member 40. In one embodiment, the waterproof member 40 is wrapped around the substrate 10, the power source 20, and the outside of the sound wave device 30 for preventing water from entering into the substrate 10, the power source 20, and the sound wave device 30. In another embodiment, the substrate 10, the power source 20, and the sound wave device 30 are separately provided with a waterproof member 40. It can be understood that when the sound wave emission system 100 is provided in an external waterproof device, the waterproof member 40 may be omitted.

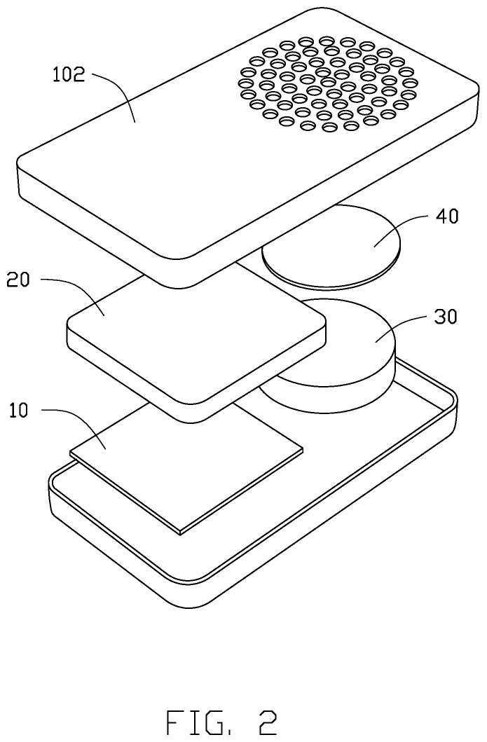

Referring to FIG. 2, in another embodiment the sound wave emission system 100 is housed in a housing 102. The substrate 10, the power source 20, and the sound wave device 30 are all mounted in the housing 102, and the housing 102 is provided with the waterproof member 40. The housing 102 may be provided with a strap for wrapping on a user's arm, leg, or other parts of the body.

In one embodiment, the sound wave emission system 100 further includes a light (not shown) connected to the power supply 20, and a switch of the light is controlled wirelessly or manually by the control system for emitting light underwater, which may be used to attract fish and for safety.

The sound wave device 30 is wirelessly connected to the control system, which is convenient for controlling the sound wave device 30. The setting unit sets the volume, rhythm, and other parameters of the sound waves to simulate the sounds of different kinds of fish in different situations, which can realize multiple functions. The sound wave emission system 100 can not only be applied to fish marks to attract fish to facilitate fishing, but also can be directly used on the human body, life jackets, goggles, and other diving equipment in a wide range of applicable scenarios.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A sound wave emission system comprising:
a substrate;
a sound wave device mounted on the substrate and configured to emit sound waves; and
a power source mounted on the substrate and electrically coupled to the sound wave device; wherein:
the volume, rhythm, and duration of the sound waves emitted by the sound wave device are controlled to simulate sounds of different kinds of fish in different situations.

2. The sound wave emission system of claim 1, wherein:
the sound wave device receives control commands for controlling the volume, rhythm, and duration of the sound waves.

3. The sound wave emission system of claim 2, wherein:
the sound wave device is wirelessly controlled to emit the sound waves.

4. The sound wave emission system of claim 3, wherein:
the volume, rhythm, and duration of the sound waves of the different kinds of fish in different situations are stored in the sound wave emission system.

5. The sound wave emission system of claim 4, further comprising a housing, wherein:
the substrate, the power supply, and the sound wave device are mounted in the housing.

6. The sound wave emission system of claim 5, further comprising a waterproof member covering the substrate, the power supply, and the sound wave device.

7. A fishing bobber comprising a sound wave emission system received in the fishing bobber, the sound wave emission system comprising:
a substrate;
a sound wave device mounted on the substrate and configured to emit sound waves; and
a power source mounted on the substrate and electrically coupled to the sound wave device; wherein:
the volume, rhythm, and duration of the sound waves emitted by the sound wave device are controlled to simulate sounds of different kinds of fish in different situations.

8. The fishing bobber of claim 7, wherein:
the sound wave device receives control commands for controlling the volume, rhythm, and duration of the sound waves.

9. The fishing bobber of claim 8, wherein:
the sound wave device is wirelessly controlled to emit the sound waves.

10. The fishing bobber of claim 9, wherein:
the volume, rhythm, and duration of the sound waves of the different kinds of fish in different situations are stored in the sound wave emission system.

11. The fishing bobber of claim 10, wherein:
the sound wave emission system further comprises a waterproof member covering the substrate, the power supply, and the sound wave device.
